(19) United States
(12) Patent Application Publication
(10) Pub. No.: US 2022/0403533 A1
(43) Pub. Date: Dec. 22, 2022

(54) APPLICATION OF HIGH CONDUCTIVITY ELECTRODES IN THE ELECTROLYSIS OF WATER

(71) Applicant: Rodolfo Antonio M Gomez, South Australia (AU)

(72) Inventor: Rodolfo Antonio M Gomez, South Australia (AU)

(21) Appl. No.: 17/776,166

(22) PCT Filed: Feb. 26, 2021
(86) PCT No.: PCT/AU2021/050165

§ 371 Date: May 11, 2022

(30) Foreign Application Priority Data
Feb. 28, 2020 (AU) 2020900594

(51) Int. Cl. C25B 1/04; C25B 11/081; C25B 13/02; C25B 9/19; C25B 9/63; C25B 11/065

(52) U.S. Cl. CPC C25B 1/04; C25B 11/081; C25B 13/02; C25B 9/19; C25B 9/63; C25B 11/065

(57) ABSTRACT

The present invention relates to the application of high electrical conductivity electrodes in whatever type of the electrolysis of water to produce hydrogen to substantially reduce power consumption. The high electrical conductivity electrodes are selected from copper electrodes or graphene electrodes and are coated with a catalyst. Type of electrolysis may be conventional diaphragm or membrane type, diaphragm-less or Unipolar electrolysis of water to produce hydrogen.

### TECHNICAL FIELD

The present invention relates to the application of highly conductive electrodes having catalytic coatings in the electrolysis of water to produce hydrogen.

### BACKGROUND

Despite advancements the production of renewable and clean energy from various means, there is still a demand for clean and renewable energy sources to negate the adverse effects of utilizing hydrocarbon fuels and the release of carbon into the atmosphere. Hydrogen production is one such proposed solution as it is a clean fuel, producing only water when consumed.

However, currently the majority of hydrogen, is industrially produced from the gasification of fossil fuels such as natural gas, oil and coal. However, these processes still lead to the emission of carbon dioxides. Therefore, as hydrogen is not generally obtained from carbon oxide free sources, it is not carbon neutral energy source.

Accordingly, there is a growing and renewed interest and need for the production of hydrogen through the electrolysis of water. the disadvantage of these conventional electrolytic cells resides, in part, in the production of low energy efficiencies.

In U.S. Pat. No. 7,326,329 and related United Kingdom Patent GB2409865 and Australian Patent 2004237840 titled “Commercial Production of Hydrogen from Water”, there is proposed a process for the production of hydrogen from the unipolar electrolysis of water, wherein more hydrogen is produced from the same energy to produce 1 mol of hydrogen from the electrolysis of water. The limitation of this invention is that the capacity of the system is limited by the cell voltage that is allowed to avoid the production of hydrogen and oxygen in the same cell, although this may be overcome by several methods such as the use of catalyst coating that has a high over-voltage for the production of the unwanted hydrogen or oxygen in the cell.

In US patent 7, 326,329 of a diaphragm-less electrolysis of water to produce hydrogen, there is practical limitation on the low voltage that can be applied to the diaphragm-less electrolytic cell. The reason is that the voltage at the cathode and anode cells is proportional to the gap between the cathode electrode and the cathode solution electrode and the voltage at the anode cell is proportional to the gap between the anode electrode and the anode solution electrode with the total ell voltage being the sum of the cathode cell voltage and the anode cell voltage. If the practical gap at the cathode is 3 mm, the gap at the anode will be 12 mm. To achieve 0.401 volts at the anode, the cell voltage would be 0.501 volts. The flowrate of the electrolytes will be an issue because the flowrate at the anode would be about 4 times the flowrate at the cathode to achieve the same velocity or turbulence at the mesh electrodes. With the diaphragm or membrane electrolytic cell, the cell voltage can be from 0.401 volts to any desired voltage for the optimum operation of the cell.

Objects and advantages of the present invention will become apparent from the following description, taking in connection with the accompanying drawings, wherein, by way of illustration and example, an embodiment of the present invention is disclosed.

### SUMMARY OF THE INVENTION

According to a first form of the invention, although this should not be seen as limiting, there is a process and/or apparatus when used for the electrolysis of water, including a electrolytic cell, the electrolytic cell including:
highly electrically conductive electrodes coated with a catalyst.

In some embodiments, the highly electrically conductive electrodes are selected from copper electrodes or graphene electrodes or combinations thereof.

In some embodiments, the electrolytic cell further includes at least one highly conductive membrane.

In some embodiments, the at least one highly conductive membrane are selected from copper membranes or graphene membranes or combinations thereof.

In some embodiments, the highly electrically conductive electrodes are coated in metals or oxides of one or more of the following: platinum, iridium, nickel, cobalt, strontium, ruthenium, gold.

In some embodiments, the at least one highly conductive membrane is coated in metals or oxides of one or more of the following: platinum, iridium, nickel, cobalt, strontium, ruthenium, gold.

In some embodiments, the apparatus and/or process can be used in conventional or diaphragm-less unipolar, or membrane unipolar electrolysis of water.

In some embodiments, when the process or apparatus is used in the membrane unipolar electrolysis of water, the electrolytic cell comprises at least first electrolytic cell having at least one anode compartment housing an highly electrically conductive anode electrode and alkaline electrolyte producing oxygen and at least one cathode compartment housing a highly electrically conductive cathode electrode and acidic electrolyte producing hydrogen with a partition member separating the anode compartment from the cathode compartment and a DC supply applied to the anode and cathode electrodes;
at least a second electrolytic cell having at least one cathode compartment housing a highly electrically conductive cathode electrode receiving the positively charged alkaline electrolyte from the first anode cell and producing hydrogen, and having at least one anode compartment housing a highly electrically conductive anode electrode and receiving the negatively charged acidic electrolyte from the first cathode cell and producing oxygen with a partition member separating the anode cell from the cathode cell, when the highly electrically conductive anode electrodes and the highly electrically conductive cathode electrodes are connected in short circuit;
wherein at least there is one partition member separating the anode and
cathode compartments in each of the first and second electrolytic cells; and wherein the partition member is a porous diaphragm or an electronic membrane.

In some embodiments, the highly electrically conductive anode electrode and the highly electrically conductive cathode electrode are selected from copper electrodes or graphene electrodes or combinations thereof.

In some embodiments, the copper electrodes or graphene electrodes or combinations thereof are coated in a first coating comprising at least one metal or metal oxides of one or more of the following: platinum, iridium, nickel, cobalt, strontium, ruthenium, gold.

In some embodiments, a system comprising and electrolytic cell, the electrolytic cell having at least one highly electrically conductive electrode is provided. The at least one highly electrically conductive electrode comprising and electrically conductive substrate, and a catalytic coating, the catalytic coating consisting of a metal or metal oxide.

In some embodiments, the metal or metal oxide of the catalytic coating is selected from the group of metals or metal oxides of one or more of the following: platinum, iridium, nickel, cobalt, strontium, ruthenium, gold.

In some embodiments, the at least one highly electrically conductive electrode is a copper electrode or a graphene electrode.

In some embodiments a conducting member extends between and connects the anode and cathode compartments in each of the first and second electrolytic cells.

In some embodiments the conducting member is selected from a group consisting of a diaphragm, an electrolytic membrane, salt bridge, semi-conductor or conductor member that allows only electrons to pass through but not ions.

In some embodiments, the partition separating the anode and cathode compartments in each of the first and second electrolytic cells is a porous diaphragm.

In some embodiments, the partition separating the anode and cathode compartments in each of the first and second electrolytic cells is an electrolytic member.

### BRIEF DESCRIPTION OF THE DRAWINGS

For a better understanding of the present invention and associated method of use, it will now be described with respect to the preferred embodiment which shall be described herein with reference to the accompanying drawings wherein:

FIG. 1A shows a diagrammatic view a conventional water electrolysis cell with an alkaline electrolyte;

FIG. 1B shows a diagrammatic view a conventional water electrolysis cell with an acidic electrolyte;

FIG. 1C shows a diagrammatic view a membrane unipolar electrolysis cell;

FIG. 2 is a diagrammatic plan view of the principle of membrane unipolar electrolysis of water;

FIG. 3 is a process diagram of a process flow diagram of a preliminary test cell using a membrane unipolar electrolytic cell;

FIG. 4 is a process flow diagram of a single cell membrane unipolar electrolytic cell;

FIG. 5 is a diagrammatic view of a cross section of a cell from FIG. 4.

### DESCRIPTION

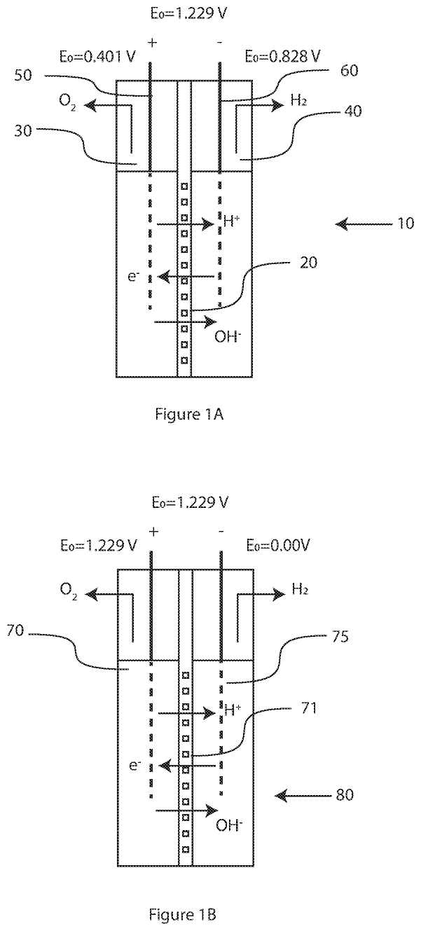

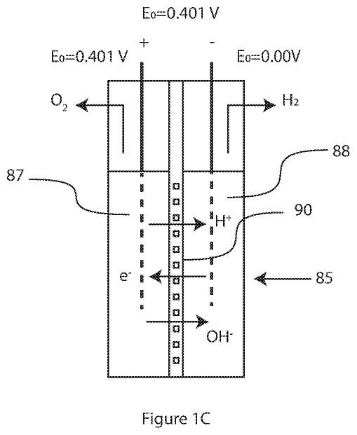

FIG. 1A shows a conventional water electrolysis cell 10 which includes an alkaline electrolyte. In conventional water electrolysis, either acid or alkaline electrolyte, electrons can travel from the cathode to the anode side electrode and ions travel in either direction through the diaphragm membrane 20. On the anode side 30, where the anode 50 resides, oxygen is produced, on the cathode side 40, hydrogen is produced.

In FIG. 1B there is shown a conventional water electrolysis cell that includes an acidic electrolyte. Oxygen is produced at the anode side 70 and hydrogen produced on the cathode side 75 noting the differential between the voltage for the respective anode separated with the diaphragm membrane 71 and cathode sides compared to the conventional water electrolysis cell utilising alkaline electrolyte as shown in FIG. 1A.

In FIG. 1C shows a membrane unipolar electrolytic cell 85, with the anode side 87, cathode side 88 with a membrane 90.

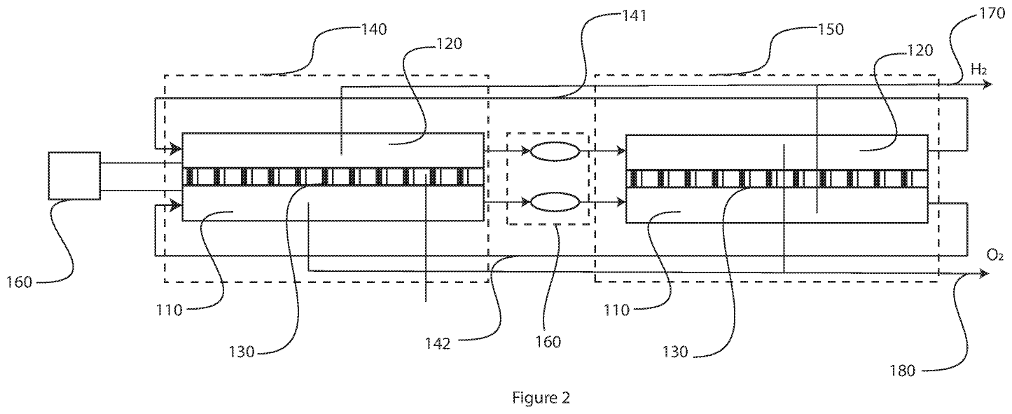

FIG. 2 shows on one side of the cell and acidic electrolyte 110 and on the other side alkaline electrolyte 120, the electrolytes being separated by the membrane 130 and a process of build-up of negative hydroxide ions at the cathode cell and the build-up of positive hydrogen ions at the anode cell. Acidic electrolysis along path 141 and alkaline electrolysis along path 142

The charging cells 140 and the neutralising cells 150 are separated by a degassing 160. Power is supplied by the DC power supply 160 the cathode producing hydrogen 170 and the anode producing oxygen 180.

Experiments on Membrane Electrolytic Cell

A conventional electrolytic cell may use alkaline electrolyte such as potassium hydroxide with the cathode half-cell voltage of 0.828 volts and the anode half-cell voltage of 0.401 volts and the total cell voltage is 1.229 volts. If an acid electrolyte is used, the cathode half-cell voltage is 0.00 volts while the anode half-cell voltage is 1.229 volts with the total cell voltage of 1.229 volts. In either case, the diaphragm or membrane between the anode and cathode cell, allows electrons and ions to pass between the cathode and anode cells.

In membrane unipolar cells the electrolyte at the cathode cell is acidic with the half-cell voltage of 0.00 volts while the electrolyte at the anode cell is alkaline with the anode half-cell voltage being 0.401 volts, which results in the total cell voltage of 0.401 volts.

The membrane of the unipolar electrolytic cell allows only electrons to flow between the cathode and anode cells and this results in the build-up of negative OH⁻ ions at the cathode cell and the build-up of H+ ions at the anode cell as shown in FIG. 2.

After de-gassing, the electrolytes are passed through another set of electrolytic cells of similar design and as the electrolytes are neutralized, current flows and another lot of hydrogen and oxygen are produced.

An estimate of the hydrogen produced by membrane unipolar electrolysis for the same energy needed to produce 1 mol of hydrogen by conventional electrolysis is 1.229/0.401×2=6.13 times.

### Experimental Results

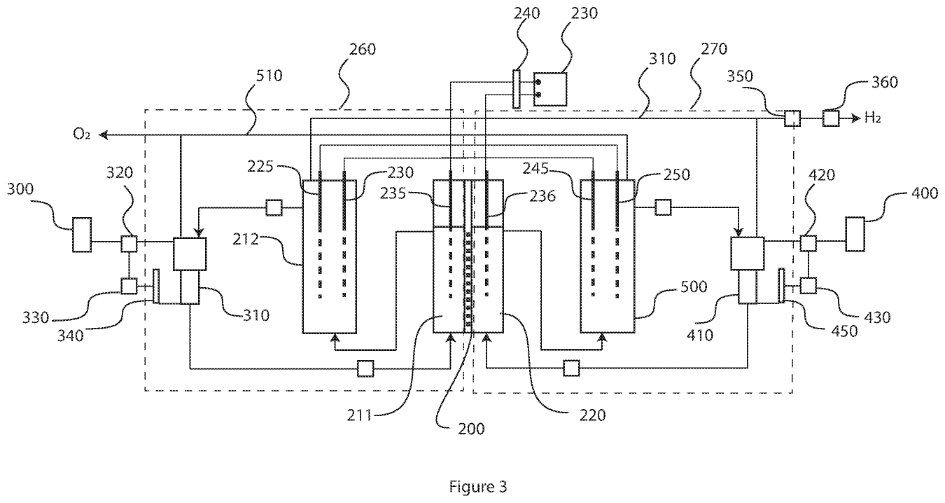

From the presently available electrode manufacturers, the only electrodes commercially available are titanium mesh electrodes coated with platinum/iridium. Of the titanium coated electrodes, those that are 90% Pt/10% Ir coated titanium electrodes are generally determined to most efficient in the production of hydrogen from the electrolysis of water using the test apparatus as shown in FIG. 3 with 120 mm×1000 mm 90% Pt/10% Ir coated titanium electrodes.

FIG. 3 shows a diagrammatic view of a process diagram for preliminary tests of a membrane unipolar electrolytic cell.

The cell 200 includes an anode cell or compartment 210 and a cathode cell or compartment 220 with power being supplied by the DC supply 230 via the modulator 240 at approximately 1.5 to 2 volts, 72 amperes. The electrodes 225, 230, 235, 236, 245 and 250 are, in this example, electrodes made of a titanium mesh coated with platinum/iridium. On the alkaline side of the diagram, 260, the water supply 300 is pumped to a pump box 310 by the pump 320 which is controlled by a PLC (programmed logic controller) 330 operatively connected to a level indicator 340 which senses the level in the pump box 310. Alkaline electrolyte from the alkaline box 310 is then pumped into the anode compartment 211 of the cell 200 with the electrode 235 and then into the compartment 212 with the electrodes 225 and 230, hydrogen produced in the cell 212 is withdrawn along the hydrogen line 310 by vacuum pump 350, the percentage of hydrogen being determined by way of a suitable hydrogen meter 360. The hydrogen can be collected from the line 310 as required.

On the acid side 270 of the diagram, the water supply 400 is pumped to the pump box 410 by the pump 420, the pump 420 being controlled by the PLC 430 that is operatively connected to the level indicator 450 of the pump box 410. The acidic electrolyte in the top box 410 is then pumped to the cathode compartment 213 of the cell 200 with the electrode 240. The electrolyte then passes to the cell 500 with electrodes 245 and 250, said electrodes being connected to electrode 230 and 225 respectively of the alkaline cell 212. Oxygen produced in cell 500 is withdrawn along the oxygen line 510 by the vacuum pump 520.

The test apparatus operated with the 90% Pt/10% Ir coated titanium electrodes operated well but failed to reach a desired objective of securing 72 amperes at low voltage of 1.6 volts indicated in FIG. 3 was not achieved. The currents secured using 50% potassium hydroxide anode electrolyte and 25% phosphoric acid without the modulator are shown in the following Table 1:

TABLE 1

| Cell voltage | Total current, Amperes |
|---|---|
| 0.60 | 0.00 |
| 0.80 | 0.00 |
| 1.00 | 0.00 |
| 1.20 | 0.00 |
| 1.40 | 0.00 |
| 1.60 | 0.10 |
| 1.80 | 0.30 |
| 2.00 | 0.90 |

### Cell Current Using Titanium Electrodes Coated with Platinum/Iridium Catalyst

While earlier work involving membrane unipolar cells using alkaline and acid electrolyte using alkaline and acid electrolyte indicated that only 0.401 volts was required to produce hydrogen in a membrane Unipolar cell using alkaline and acid electrolyte, there is another law that governs this electrolytic cell, the direct current electrical law:

Cell voltage=Current (amperes)×Resistance (ohms)

With low cell voltage, if large current is required, the electrical resistance of the cell must be very low.

Copper electrodes coated properly with platinum/iridium catalyst can be difficult and/or expensive to source on a commercial basis. Conventional methods of manufacturing titanium electrodes coated with platinum/iridium involves painting a platinum/iridium coating onto the surface of a titanium electrode and then expose the painted titanium electrode to heat to very high temperature in order to effectively bind the platinum/iridium catalyst to the titanium electrode. Copper has a low melting point (1084° C.) compared to titanium (1668° C.), and so the procedure for coating titanium electrodes with platinum/iridium catalyst cannot be used for coating copper electrodes.

The present inventors developed a solution to coat copper electrodes with the appropriate catalyst in which the electrode, such as a copper mesh electrode or copper membrane, is painted with a solution of the platinum/iridium catalyst.

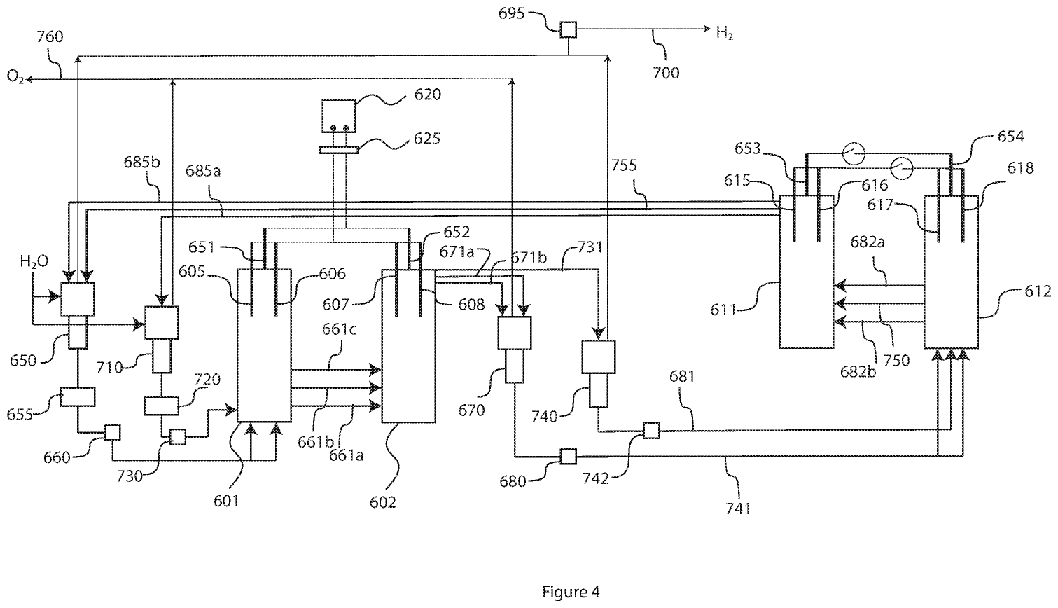

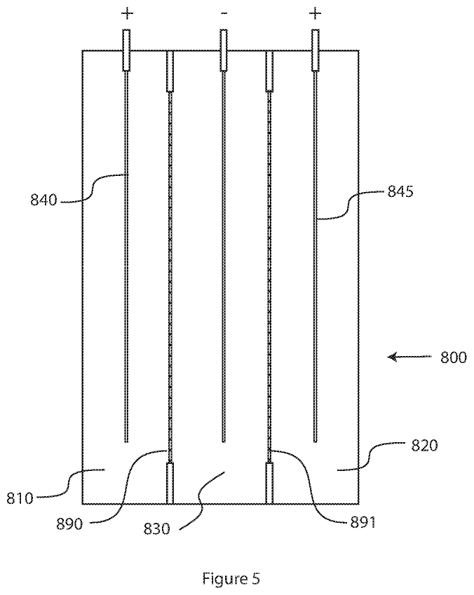

The copper electrodes and the copper membranes produced by this process are not expected to last in the alkaline and acid electrolytes with a temperature of 90° C. In FIG. 4 the process flow diagram shows charging cells 601 and 602 and neutralising cells 611 and 612 with power being supplied to the charging cells 601, 602 by the DC power supply 620 via modulator 625 to the electrodes 605 and 606 of charging cell 601, and electrodes 607 and 608 of charging cell 602. In the neutralising cells 611 and 612 the electrodes 615 and 616 of cell 611 are connected to the electrodes 617 and 618 of cell 612.

In FIG. 4 the electrodes 605, 606, 607, 608, 615, 616, 617, 618 (anodes) and electrodes 651, 652, 653 and 654 (cathodes) are copper electrodes prepared by the present invention via painting with a platinum/iridium catalyst.

The alkaline pump box 650, which includes a spray unit, delivers alkaline electrolyte to a heater component 655, the alkaline electrolyte then being pumped by the alkaline pump 660 into the charging cell 601, which is fluidly connected to charging cell 602 by line 661a and 661c. Alkaline electrolyte from the charging cells 601, 602 is then passed to the alkaline pump box 670, without spraying, which is then subsequently pumped to the neutralising cell 612 by action of the alkaline pump 680 along line 681. Neutralising cell 612 is fluidly connected to neutralising cell 611 by the line 682. After passing through the neutralising cells 611 and 612, the alkaline electrolyte is returned to the alkaline pump box 650 via lines 685, produced hydrogen travels along line 690 through a drip trap 695 and through to hydrogen collection 700.

Acidic electrolyte is pumped from the acidic electrolyte box 710, without the use of a spray, through to the heater 720 and pumped by the acid electrolyte pump 730 into the charging cells 601, by line 661b into cell 602. Acidic electrolyte then passes through the line 731 to the acidic electrolyte pump box 740, with spraying, where it is then pumped along line 741 by pump 742 into the neutralising cell 612, which is connected to the neutralising cell 611 by the line 750 ultimately returning along line 755 to the pump box 710, without spraying. Oxygen produced during electrolysis is collected at 710 and 670, through the collection lines 56 and 671 to the oxygen collection 760.

The electrolyte solutions exiting the first electrolytic cell 601 are positively and negatively charged and these charged electrolyte solutions are passed through the second electrolytic cell 602 where the electrolyte are short circuited. Faraday's law provides that when current flows, substances are produced at the anode and cathode electrodes. In this case, hydrogen is produced at the anode electrodes and oxygen is produced at the cathode electrodes.

The cells shown in FIG. 4 are shown in the representative cell cross section of FIG. 5 in which the cell 800 has the outer wall 801 and anode compartments 810 and 820 with a cathode compartment 830 positioned between. The alkaline compartments 810 and 820 contain an alkaline electrolyte, in this example 27% KOH. The cathode compartment 830 has an acidic electrolyte, in this example 50% H₃PO₄. The anode compartments 810 and 820 include the anode electrodes 840 0 and 845 being copper electrodes with the platinum/iridium catalyst, measuring 120 mm×1000 mm. Membranes (partition membrane) 890 and 891 separate the cathode compartment from the adjacent anode compartments.

From our tests it was observed that the initial current at 0.60 cell voltage was 50 amperes, which was quite unexpected. The currents at different cell voltages were tested and the observations are shown on Table 2

TABLE 2

| Cell voltage | Total current, Amperes |
|---|---|
| 0.60 | 50 |
| 0.60 | 9.9 |
| 0.80 | 10.7 |
| 1.00 | 28 |
| 1.20 | 48.7 |
| 1.40 | 71.7 |
| 1.60 | 92.5 |
| 1.80 | — |

### Cell Current Using Copper Electrodes Coated with Platinum/Iridium Catalyst

The use of copper electrodes of the present invention, coated with platinum/iridium catalyst, in the single cell membrane unipolar electrolysis apparatus surprisingly and unexpectedly increased the current substantially at a low voltage. At 0.6 volts cell voltage, the initial current was 50 amperes before the painted catalyst coating deteriorated. Conventional water electrolysis process shows that electrolysis does not proceed below 1.229 cell voltage.

Conventional water electrolysis provides that theoretical energy required to produce one kilogram of hydrogen is 39 kilowatt-hours (kwh). Cell membrane unipolar electrolysis of water predicts 6.13 kwh per kilogram of hydrogen.

In our experiments, using the copper electrodes coated with platinum/iridium catalyst and using a cell voltage of 0.6 volts and 50 amperes, the energy required to produce one kilogram of hydrogen is 17.51 kwh. The US National Renewable Energy Laboratory publications suggest that the best commercial energy consumption to produce hydrogen is 53.4 kwh per kilogram.

The present invention shows that membrane Unipolar electrolysis of water using high electrical conductivity electrodes, such as the copper electrodes plated with a platinum/iridium catalyst offers substantial reduction in the energy required to produce green hydrogen and this will translate to a substantial reduction in the cost of producing green hydrogen.

1-12. (canceled)

13. An apparatus when used for the electrolysis of water, including an electrolytic cell, the electrolytic cell including electrically conductive electrodes coated with a catalyst, wherein the electrically conductive electrodes are selected from copper electrodes or graphene electrodes or combinations thereof,
wherein when the electrolytic cell comprises at least a first electrolytic cell having at least one anode compartment housing an electrically conductive anode electrode and alkaline electrolyte producing oxygen and at least one cathode compartment housing a electrically conductive cathode electrode and acidic electrolyte producing hydrogen with a partition member separating the anode compartment from the cathode compartment and a DC supply applied to the anode and cathode electrodes;
at least a second electrolytic cell having at least one cathode compartment housing a electrically conductive cathode electrode receiving the positively charged alkaline electrolyte from the first anode cell and producing hydrogen, and having at least one anode compartment housing a electrically conductive anode electrode and receiving the negatively charged acidic electrolyte from the first cathode cell and producing oxygen with a partition member separating the anode cell from the cathode cell, when the electrically conductive anode electrodes and the electrically conductive cathode electrodes are connected in short circuit;
wherein there is at least one partition member separating the anode and cathode compartments in each of the first and second electrolytic cells; and
wherein the partition member is a porous diaphragm or an electrolytic membrane.

14. The apparatus of claim 13, wherein the electrolytic cell further includes at least one conductive membrane.

15. The apparatus of claim 14, wherein the at least one conductive membrane is selected from copper membranes or graphene membranes or combinations thereof.

16. The apparatus of claim 13, wherein the electrically conductive electrodes are coated in metals or oxides of one or more of the following: platinum, iridium, nickel, cobalt, strontium, ruthenium, gold.

17. The apparatus of claim 15, wherein the at least one conductive membrane is coated in metals or oxides of one or more of the following: platinum, iridium, nickel, cobalt, strontium, ruthenium, gold.

18. The apparatus of claim 13, wherein the apparatus can be used in at least one of:
conventional unipolar electrolysis of water or
diaphragm-less unipolar electrolysis of water, or
membrane unipolar electrolysis of water.

19. The apparatus of claim 13, wherein the copper electrodes or graphene electrodes or combinations thereof are coated in a first coating comprising at least one metal or metal oxides of one or more of the following: platinum, iridium, nickel, cobalt, strontium, ruthenium, gold.
